(19) United States
(12) Patent Application Publication
(10) Pub. No.: US 2013/0187901 A1
(43) Pub. Date: Jul. 25, 2013

(54) CIRCUIT FOR OUTPUTTING OVERDRIVE VOLTAGES OF A LIQUID CRYSTAL PANEL AND METHOD THEREOF

(71) Applicants: Chun-Chieh Chiu, Taoyuan County (TW); Hsiang-Tan Lin, Keelung City (TW); Tzu-Chiang Shen, Taoyuan County (TW); Chien-Hung Chen, New Taipei City (TW)

(72) Inventors: Chun-Chieh Chiu, Taoyuan County (TW); Hsiang-Tan Lin, Keelung City (TW); Tzu-Chiang Shen, Taoyuan County (TW); Chien-Hung Chen, New Taipei City (TW)

(21) Appl. No.: 13/426,615

(22) Filed: Mar. 22, 2012

(30) Foreign Application Priority Data
Jan. 19, 2012 (TW) 101102177

(51) Int. Cl. G09G 3/36; G09G 5/00

(52) U.S. Cl. 345/212; 345/87

(57) ABSTRACT

A circuit for outputting overdrive voltages of a liquid crystal panel includes a memory unit and an overdrive unit. The overdrive unit includes a first lookup table, a second lookup table, and a selector. The memory unit stores a plurality of second pixel voltages corresponding to a second frame displayed by the liquid crystal panel and outputs a plurality of first pixel voltages corresponding to a first frame displayed by the liquid crystal panel stored in the memory unit. The overdrive unit looks up the first lookup table and the second lookup table to generate a first overdrive voltage and a second overdrive voltage according to each first pixel voltage and a corresponding second pixel voltage. The selector outputs the first overdrive voltage or the second overdrive voltage according to a polarity signal and a frame signal.

### BACKGROUND OF THE INVENTION

1. Field of the Invention

The present invention relates to a circuit for outputting overdrive voltages of a liquid crystal panel and a method thereof, and particularly to a circuit for outputting overdrive voltages of a liquid crystal panel and a method thereof that can solve crosstalk of a liquid crystal panel whose inversion type is 2 frame inversion type.

2. Description of the Prior Art

Please refer to FIG. 1, FIG. 2A, and FIG. 2B. FIG. 1 is a diagram illustrating a liquid crystal panel 100 whose inversion type is 2 frame inversion type, and FIG. 2A and FIG. 2B are diagrams illustrating charge conditions of a pixel of the liquid crystal panel 100. As shown in FIG. 1, the liquid crystal panel 100 is composed of a plurality of pixels, and polarity of the plurality of pixels is inverted each two frames. That is to say, polarity of a frame FN is the same as polarity of a frame FN+1, polarity of a frame FN+2 is the same as polarity of a frame FN+3, and the polarity of the frame FN and the frame FN+1 is opposite the polarity of the frame FN+2 and the frame FN+3. As shown in FIG. 2A, at an interval T1, a pixel of the liquid crystal panel 100 is written in a left eye image of a three-dimensional image having a gray level voltage G32, where L represents the left eye image of the three-dimensional image, and +W represents the pixel has positive polarity and insufficient charges; at an interval T2, the pixel of the liquid crystal panel 100 is written in a right eye image of the three-dimensional image having a gray level voltage G128, where R represents the right eye image of the three-dimensional image, and +S represents the pixel has positive polarity and sufficient charges; at an interval T3, the pixel of the liquid crystal panel 100 is written in a left eye image of the three-dimensional image having a gray level voltage G32, where −W represents the pixel has negative polarity and insufficient charges; and at an interval T4, the pixel of the liquid crystal panel 100 is written in a right eye image of the three-dimensional image with a gray level voltage G128, where −S represents the pixel has negative polarity and sufficient charges. Similarly, as shown in FIG. 2B, at an interval T1, a pixel of the liquid crystal panel 100 is written in a left eye image of a three-dimensional image having a gray level voltage G128; at an interval T2, the pixel of the liquid crystal panel 100 is written in a right eye image of the three-dimensional image having a gray level voltage G32; at an interval T3, the pixel of the liquid crystal panel 100 is written in a left eye image of the three-dimensional image having a gray level voltage G128; and at an interval T4, the pixel of the liquid crystal panel 100 is written in a right eye image of the three-dimensional image having a gray level voltage G32. In addition, in FIG. 2A and FIG. 2B, VCOM is a common voltage of the liquid crystal panel 100.

As shown in FIG. 2A and FIG. 2B, the gray level voltage G128 of the left eye image of the three-dimensional image (+W) is not equal to the gray level voltage G128 of the right eye image of the three-dimensional image (+S); the gray level voltage G128 of the left eye image of the three-dimensional image (−W) is not equal to the gray level voltage G128 of the right eye image of the three-dimensional image (−S); the gray level voltage G32 of the left eye image of the three-dimensional image (+W) is not equal to the gray level voltage G32 of the right eye image of the three-dimensional image (+S); and the gray level voltage G32 of the left eye image of the three-dimensional image (−W) is not equal to the gray level voltage G32 of the right eye image of the three-dimensional image (−S).

In addition, in FIG. 2A, when a voltage of the pixel of the liquid crystal panel 100 is changed from the gray level voltage G32 (L, +W) to the gray level voltage G128 (R, +S), a corresponding voltage drop V1 can be generated according to equation (1). In FIG. 2B, when the pixel of the liquid crystal panel 100 is changed from the gray level voltage G32 (R, +S) to the gray level voltage G128 (L, −W), a corresponding voltage drop V2 can be generated according to equation (2).

|G32(L,+W)−VCOM|−|G128(R,+S)−VCOM|=V1 (1)

|G32(R,+S)−VCOM|−|VCOM−G128(L,−W)|=V2 (2)

As shown in equation (1) andequation (2), G32(L, +W) represents the left eye image of the three-dimensional image having positive polarity, insufficient charges, and the gray level voltage G32, G32(R, +S) represents the right eye image of the three-dimensional image having positive polarity, sufficient charges, and the gray level voltage G32, G128(R, +S) represents the right eye image of the three-dimensional image having positive polarity, sufficient charges, and the gray level voltage G128, and G128(L, −W) represents the left eye image of the three-dimensional image having negative polarity, insufficient charges, and the gray level voltage G128. As shown in equation (1) and equation (2), the voltage drop V1 is not equal to the voltage drop V2, so the same overdrive voltage can not be applied to the left eye image of the three-dimensional image and the right eye image of the three-dimensional image. That is to say, if the left eye image of the three-dimensional image and the right eye image of the three-dimensional image utilize the same overdrive voltage, crosstalk may occur between the left eye image of the three-dimensional image and the right eye image of the three-dimensional image. In addition, when the liquid crystal panel 100 displays two-dimensional images, the liquid crystal panel 100 also exhibits scenarios in which the two-dimensional images can not utilize the same overdrive voltage.

### SUMMARY OF THE INVENTION

An embodiment provides a circuit for outputting overdrive voltages of a liquid crystal pane. The circuit includes a memory unit and an overdrive unit. The overdrive unit includes a first lookup table, a second lookup table, and a selector, where the first lookup table includes a plurality of first overdrive voltages and the second lookup table includes a plurality of second overdrive voltages. The memory unit is used for temporarily storing a plurality of second pixel voltages corresponding to a second frame displayed by the liquid crystal panel, and outputting a plurality of first pixel voltages corresponding to a first frame displayed by the liquid crystal panel. The overdrive unit is used for receiving the plurality of first pixel voltages and the plurality of second pixel voltages looks up the first lookup table and the second lookup table to generate a first overdrive voltage and a second overdrive voltage according to each first pixel voltage of the plurality of first pixel voltages and a second pixel voltage of the plurality of second pixel voltages corresponding to the first pixel voltage. The selector is used for receiving the first overdrive voltage and the second overdrive voltage, and outputting the first overdrive voltage or the second overdrive voltage according to a polarity signal and a frame signal of the liquid crystal panel. The first frame is a previous frame before the second frame.

Another embodiment provides a method for outputting overdrive voltages of a liquid crystal panel, where a circuit for outputting overdrive voltages of a liquid crystal panel includes a memory unit, and a overdrive unit, and the overdrive unit includes a first lookup table, a second lookup table, and a selector. The method includes the memory unit temporarily storing a plurality of second pixel voltages corresponding to a second frame displayed by the liquid crystal panel, and outputting a plurality of first pixel voltages corresponding to a first frame displayed by the liquid crystal panel stored in the memory unit; the overdrive unit receiving the plurality of first pixel voltages and the plurality of second pixel voltages; the overdrive unit looking up the first lookup table and the second lookup table to generate a first overdrive voltage and a second overdrive voltage according to each first pixel voltage of the plurality of first pixel voltages and a second pixel voltage of the plurality of second pixel voltages corresponding to the first pixel voltage; the selector receiving the first overdrive voltage and the second overdrive voltage; and the selector outputting the first overdrive voltage or the second overdrive voltage according to a polarity signal of the liquid crystal panel and a frame signal; where the first frame is a previous frame before the second frame.

The present invention provides a circuit for outputting overdrive voltages of a liquid crystal panel and a method for outputting overdrive voltages of the liquid crystal panel. The circuit and the method utilize an overdrive unit to look up a first lookup table and a second lookup table to generate a first overdrive voltage and a second overdrive voltage according to each first pixel voltage of a plurality of first pixel voltages corresponding to a first frame displayed by the liquid crystal panel and a corresponding second pixel voltage of a plurality of second pixel voltages corresponding to a second frame displayed by the liquid crystal panel. Then, a selector outputs the first overdrive voltage or the second overdrive voltage to the liquid crystal panel according to a polarity signal and a frame signal of the liquid crystal panel. Thus, the present invention utilizes the overdrive unit to generate different overdrive voltages to improve crosstalk of the liquid crystal panel having a 2 frame inversion type.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a liquid crystal panel whose inversion type is 2 frame inversion type.

FIG. 2A and FIG. 2B are diagrams illustrating charge conditions of a pixel of the liquid crystal panel.

FIG. 3 is a diagram illustrating a circuit for outputting overdrive voltages of a liquid crystal panel according to an embodiment.

FIG. 4A and FIG. 4B are timing diagrams illustrating the polarity signal, a pixel voltage of a pixel of the liquid crystal panel, and an overdrive voltage corresponding to the pixel.

FIG. 4C is a diagram illustrating the first lookup table.

FIG. 4D is a diagram illustrating the second lookup table.

FIG. 5 is a diagram illustrating a circuit for outputting overdrive voltages of a liquid crystal panel according to another embodiment.

FIG. 6 is a flowchart illustrating a method for outputting overdrive voltages of a liquid crystal panel according to another embodiment.

### DETAILED DESCRIPTION

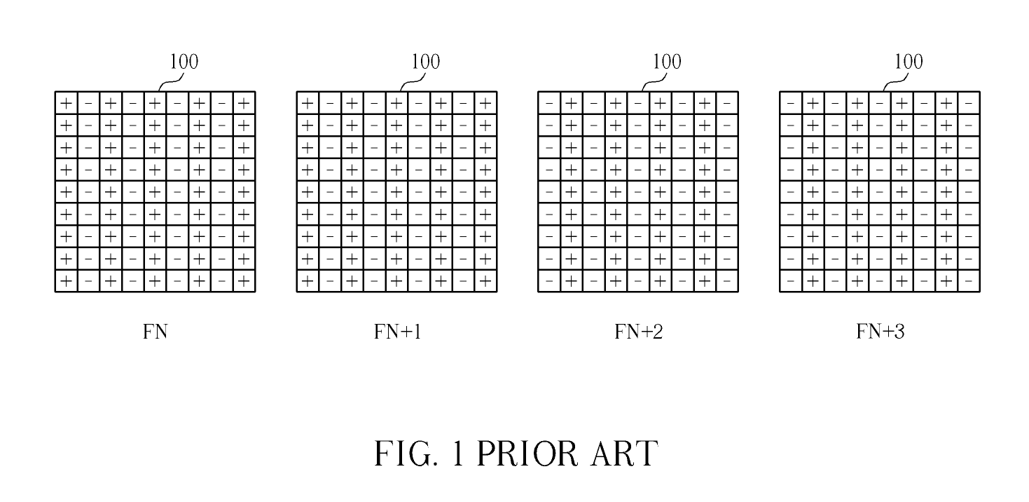

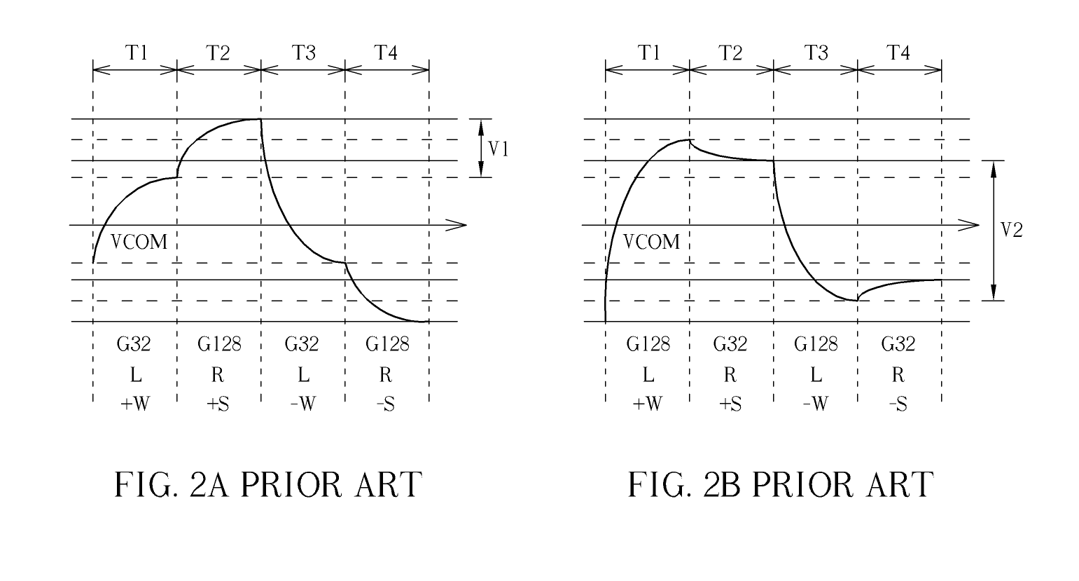

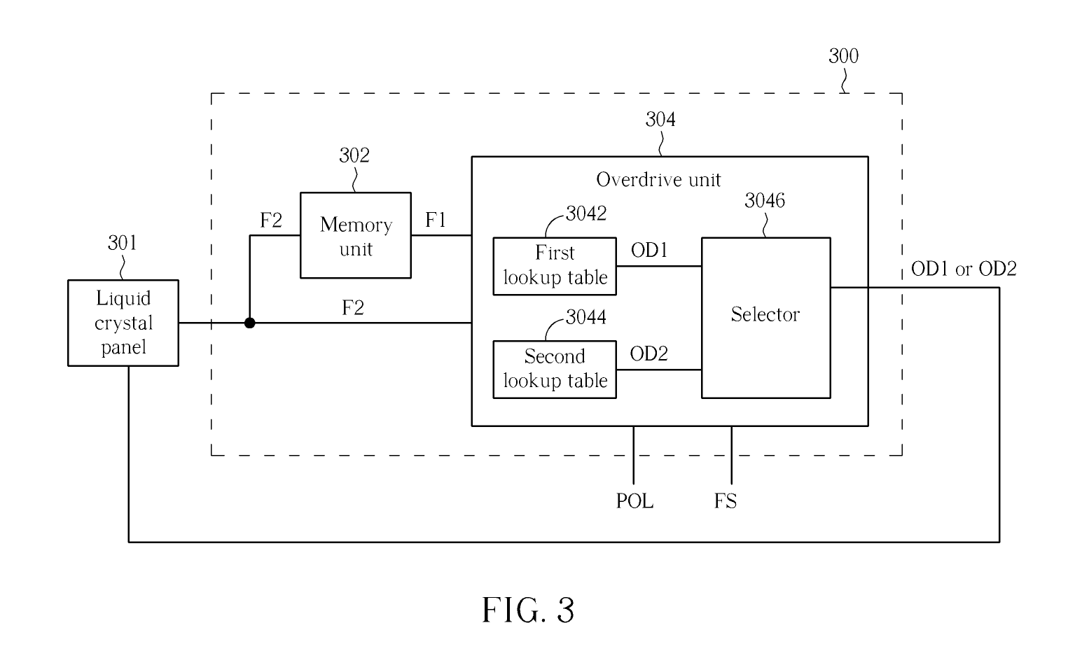

Please refer to FIG. 3. FIG. 3 is a diagram illustrating a circuit 300 for outputting overdrive voltages of a liquid crystal panel according to an embodiment. The circuit 300 includes a memory unit 302 and an overdrive unit 304. The overdrive unit 304 includes a first lookup table 3042, a second lookup table 3044, and a selector 3046, where the first lookup table 3042 includes a plurality of first overdrive voltages OD1 and the second lookup table 3044 includes a plurality of second overdrive voltages OD2. The memory unit 302 is used for temporarily storing a plurality of second pixel voltages corresponding to a second frame F2 displayed by a liquid crystal panel 301, and outputting a plurality of first pixel voltages corresponding to a first frame F1 displayed by the liquid crystal panel 301 stored in the memory unit 302. The overdrive unit 304 is used for receiving the plurality of first pixel voltages corresponding to the first frame F1 and the plurality of second pixel voltages corresponding to the second frame F2, and looking up the first lookup table 3042 and the second lookup table 3044 to generate a first overdrive voltage OD1 and a second overdrive voltage OD2 according to each first pixel voltage of the plurality of first pixel voltages corresponding to the first frame F1 and a corresponding second pixel voltage of the plurality of second pixel voltages corresponding to the second frame F2. The selector 3046 is used for receiving the first overdrive voltage OD1 and the second overdrive voltage OD2, and outputting the first overdrive voltage OD1 or the second overdrive voltage OD2 according to a polarity signal POL and a frame signal FS of the liquid crystal panel 301. In addition, the first frame F1 is a previous frame before the second frame F2. When the first frame F1 and the second frame F2 are three-dimensional image frames, the frame signal FS is a left/right eye signal. But, the present invention is not limited to the frame signal FS being the left/right eye signal when the first frame F1 and the second frame F2 are the three-dimensional image frames. That is to say, the frame signal FS can also be a vertical sync signal. In addition, the present invention is not limited to the first frame F1 and the second frame F2 being the three-dimensional image frames. That is to say, the first frame F1 and the second frame F2 can also be two-dimensional image frames. In addition, a polarity inversion type of the liquid crystal panel 301 which is the same as the polarity inversion type of the liquid crystal panel 100 in FIG. 1 is 2 frame inversion type.

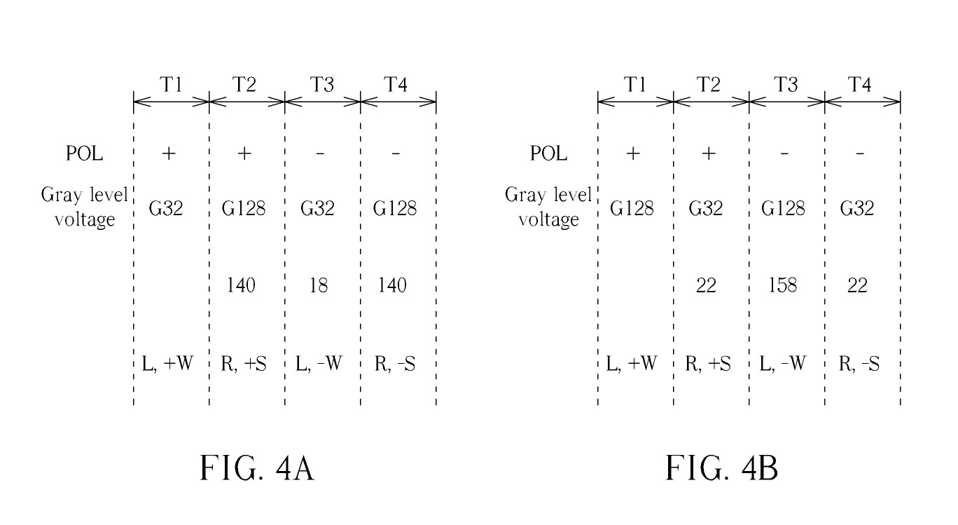

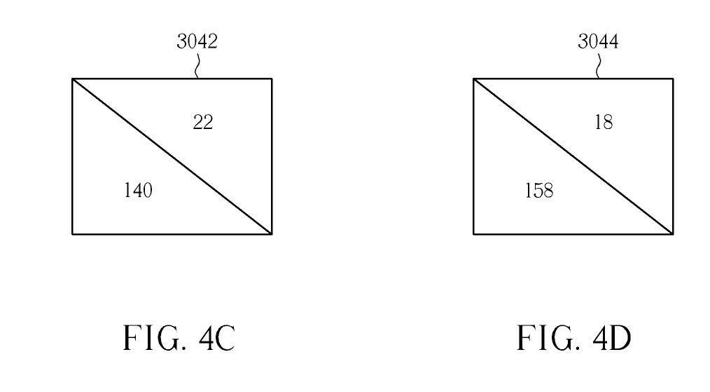

Please refer to FIG. 4A, FIG. 4B, FIG. 4C, and FIG. 4D. FIG. 4A and FIG. 4B are timing diagrams illustrating the polarity signal POL, a pixel voltage of a pixel (P) of the liquid crystal panel 301, and an overdrive voltage corresponding to the pixel (P), FIG. 4C is a diagram illustrating the first lookup table 3042, and FIG. 4D is a diagram illustrating the second lookup table 3044. As shown in FIG. 4A, at an interval T1, the pixel (P) of the liquid crystal panel 301 is written in a left eye image of a three-dimensional image having a gray level voltage G32, where L represents the left eye image of the three-dimensional image, and +W represents the pixel (P) having positive polarity and insufficient charges; at an interval T2, the pixel (P) of the liquid crystal panel 301 is written in a right eye image of the three-dimensional image having a gray level voltage G128, where R represents the right eye image of the three-dimensional image, and +S represents the pixel (P) having the positive polarity and sufficient charges; at an interval T3, the pixel (P) of the liquid crystal panel 301 is written in a left eye image of the three-dimensional image having the gray level voltage G32, where −W represents the pixel (P) having negative polarity and insufficient charges; at an interval T4, the pixel (P) of the liquid crystal panel 301 is written in a right eye image of the three-dimensional image having the gray level voltage G128, where −S represents the pixel (P) having the negative polarity and sufficient charges. As shown in FIG. 4A, at the interval T1 and the interval T2, because the pixel voltage of the pixel (P) is changed from the gray level voltage G32 (corresponding to a first frame) to the gray level voltage G128 (corresponding to a second frame), the overdrive unit 304 can look up the first lookup table 3042 and the second lookup table 3044 to generate a first overdrive voltage 140 (as shown in FIG. 4C) and a second overdrive voltage 158 (as shown in FIG. 4D) according to the gray level voltage G32 and the gray level voltage G128. Because the polarity signal POL is not changed (+→+), the selector 3046 determines that the pixel voltage of the pixel (P) is changed from the gray level voltage G32 (insufficient charges) to the gray level voltage G128 (sufficient charges) according to the polarity signal POL of the liquid crystal panel 301. Thus, the selector 3046 can output the first overdrive voltage 140 to the pixel (P) according to the frame signal FS (that is, the first frame is updated to the second frame). Similarly, as shown in FIG. 4A, at the interval T2 and the interval T3, because the pixel voltage of the pixel (P) is changed from the gray level voltage G128 (corresponding to the second frame) to the gray level voltage G32 (corresponding to a third frame), the overdrive unit 304 can look up first the lookup table 3042 and the second lookup table 3044 to generate a first overdrive voltage 22 (as shown in FIG. 4C) and a second overdrive voltage 18 (as shown in FIG. 4D) according to the gray level voltage G128 and the gray level voltage G32. Because the polarity signal POL is changed (+→−), the selector 3046 determines that the pixel voltage of a pixel (P) is changed from the gray level voltage G128 (sufficient charges) to the gray level voltage G32 (insufficient charges) according to the polarity signal POL of the liquid crystal panel 301. Thus, the selector 3046 can output the second overdrive voltage 18 to the pixel (P) according to the frame signal FS (that is, the second frame is updated to the third frame). In addition, at the interval T3 and the interval T4, subsequent operational principles of the selector 3046 outputting the first overdrive voltage 140 to the pixel (P) are the same as those of the selector 3046 outputting the first overdrive voltage 140 to the pixel (P) at the interval T1 and the interval T2, so further description thereof is omitted for simplicity.

As shown in FIG. 4B, at an interval T1, the pixel (P) of the liquid crystal panel 301 is written in a left eye image of a three-dimensional image having the gray level voltage G128, where L represents the left eye image of the three-dimensional image, and +W represents the pixel (P) having the positive polarity and insufficient charges; at an interval T2, the pixel (P) of the liquid crystal panel 301 is written in a right eye image of the three-dimensional image having the gray level voltage G32, where R represents the right eye image of the three-dimensional image, and +S represents the pixel (P) having the positive polarity and sufficient charges; at an interval T3, the pixel (P) of the liquid crystal panel 301 is written in a left eye image of the three-dimensional image having the gray level voltage G128, where −W represents the pixel (P) having the negative polarity and insufficient charges; at an interval T4, the pixel (P) of the liquid crystal panel 301 is written in a right eye image of the three-dimensional image having the gray level voltage G32, where −S represents the pixel (P) having the negative polarity and sufficient charges. As shown in FIG. 4B, at the interval T1 and the interval T2, because the pixel voltage of the pixel (P) is changed from the gray level voltage G128 (corresponding to a first frame) to the gray level voltage G32 (corresponding to a second frame), the overdrive unit 304 can lookup the first lookup table 3042 and the second lookup table 3044 to generate a first overdrive voltage 22 (as shown in FIG. 4C) and a second overdrive voltage 18 (as shown in FIG. 4D) according to the gray level voltage G128 and the gray level voltage G32. Because the polarity signal POL is not changed (+→+), the selector 3046 determines that the pixel voltage of the pixel (P) is changed from the gray level voltage G128 (insufficient charges) to the gray level voltage G32 (sufficient charges) according to the polarity signal POL of the liquid crystal panel 301. Thus, the selector 3046 can output the first overdrive voltage 22 to the pixel (P) according to the frame signal FS (that is, the first frame is updated to the second frame). Similarly, as shown in FIG. 4B, at the interval T2 and the interval T3, because the pixel voltage of the pixel (P) is changed from the gray level voltage G32 (corresponding to the second frame) to the gray level voltage G128 (corresponding to a third frame), the overdrive unit 304 can look up first the lookup table 3042 and the second lookup table 3044 to generate a first overdrive voltage 140 (as shown in FIG. 4C) and a second overdrive voltage 158 (as shown in FIG. 4D) according to the gray level voltage G32 and the gray level voltage G128. Because the polarity signal POL is changed (+→−), the selector 3046 determines that the pixel voltage of a pixel (P) is changed from the gray level voltage G32 (sufficient charges) to the gray level voltage G128 (insufficient charges) according to the polarity signal POL of the liquid crystal panel 301. Thus, the selector 3046 can output the second overdrive voltage 158 to the pixel (P) according to the frame signal FS (that is, the second frame is updated to the third frame). In addition, at the interval T3 and the interval T4, subsequent operational principles of the selector 3046 outputting the first overdrive voltage 22 to the pixel (P) are the same as those of the selector 3046 outputting the first overdrive voltage 22 to the pixel (P) at the interval T1 and the interval T2, so further description thereof is omitted for simplicity. In addition, in FIG. 4A and FIG. 4B, the present invention is not limited to the pixel (P) of the liquid crystal panel 301 being written in three-dimensional images having the gray level voltage G32 and the gray level voltage G128.

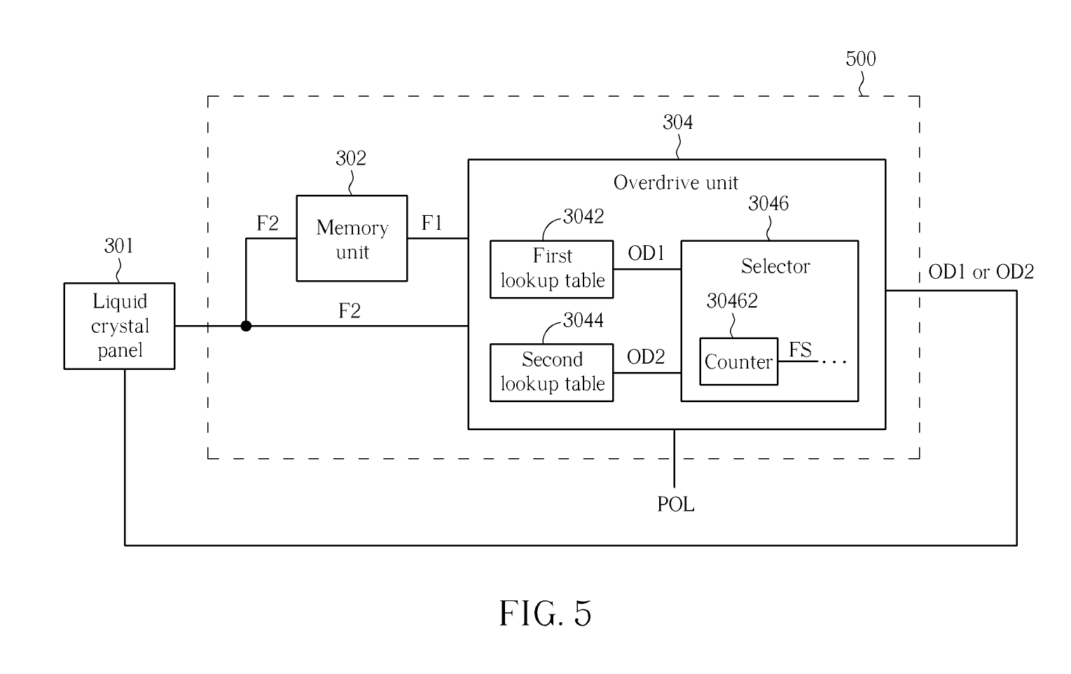

Please refer to FIG. 5. FIG. 5 is a diagram illustrating a circuit 500 for outputting overdrive voltages of a liquid crystal panel according to another embodiment. A difference between the circuit 500 and the circuit 300 is that a selector 3046 of the circuit 500 includes a counter 30462. The counter 30462 is used for generating a frame signal FS according to a period of time for the liquid crystal panel 301 displaying a frame. Then, the selector 3046 can output a first overdrive voltage OD1 or a second overdrive voltage OD2 according to a polarity signal POL of the liquid crystal panel 301 and the frame signal FS generated by the counter 30462. In addition, subsequent operational principles of the circuit 500 are the same as those of the circuit 300, so further description thereof is omitted for simplicity.

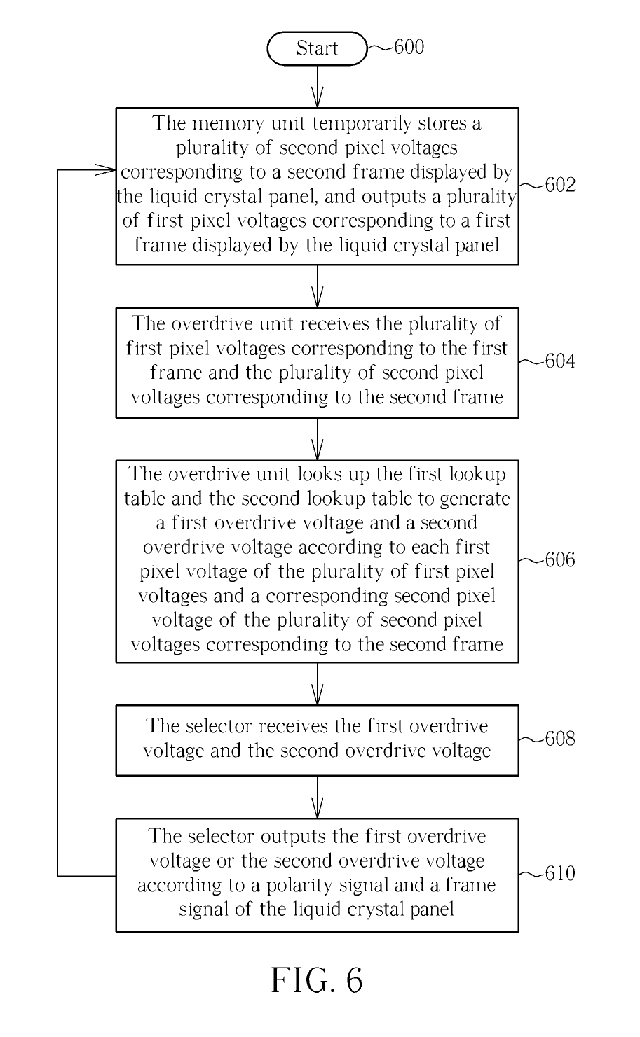

Please refer to FIG. 6, FIG. 3, FIG. 4A, FIG. 4B, FIG. 4C, FIG. 4D, and FIG. 5. FIG. 6 is a flowchart illustrating a method for outputting overdrive voltages of a liquid crystal panel according to another embodiment. The method in FIG. 6 is illustrated using the circuit 300 in FIG. 3. Detailed steps are as follows:

Step 600: Start.

Step 602: The memory unit 302 temporarily stores a plurality of second pixel voltages corresponding to a second frame F2 displayed by the liquid crystal panel 301, and outputs a plurality of first pixel voltages corresponding to a first frame F1 displayed by the liquid crystal panel 301.

Step 604: The overdrive unit 304 receives the plurality of first pixel voltages corresponding to the first frame F1 and the plurality of second pixel voltages corresponding to the second frame F2.

Step 606: The overdrive unit 304 looks up the first lookup table 3042 and the second lookup table 3044 to generate a first overdrive voltage OD1 and a second overdrive voltage OD2 according to each first pixel voltage of the plurality of first pixel voltages and a corresponding second pixel voltage of the plurality of second pixel voltages corresponding to the second frame F2.

Step 608: The selector 3046 receives the first overdrive voltage OD1 and the second overdrive voltage OD2.

Step 610: The selector 3046 outputs the first overdrive voltage OD1 or the second overdrive voltage OD2 according to a polarity signal POL and a frame signal FS of the liquid crystal panel 301; go to Step 602.

In Step 604, the first frame F1 is a previous frame before the second frame F2. In Step 606, as shown in FIG. 4A, FIG. 4C, and FIG. 4D, the overdrive unit 304 can look up the first lookup table 3042 and the second lookup table 3044 to generate a first overdrive voltage 140 (as shown in FIG. 4C) and a second overdrive voltage 158 (as shown in FIG. 4D) according to a gray level voltage G32 and a gray level voltage G128; as shown in FIG. 4B, FIG. 4C, and FIG. 4D, the overdrive unit 304 can look up the first lookup table 3042 and the second lookup table 3044 to generate a first overdrive voltage 22 (as shown in FIG. 4C) and a second overdrive voltage 18 (as shown in FIG. 4D) according to a gray level voltage G128 and a gray level voltage G32. In Step 610, as shown in FIG. 4A, FIG. 4C, and FIG. 4D, at an interval T1 and an interval T2, because the polarity signal POL is not changed (+→+), the selector 3046 determines that a pixel voltage of a pixel (P) is changed from the gray level voltage G32 (insufficient charges) to the gray level voltage G128 (sufficient charges) according to the polarity signal POL of the liquid crystal panel 301. Thus, the selector 3046 can output the first overdrive voltage 140 to the pixel (P) according to the frame signal FS (that is, the first frame is updated to the second frame). At the interval T2 and an interval T3, because the polarity signal POL is changed (+→−), the selector 3046 determines that the pixel voltage of the pixel (P) is changed from the gray level voltage G128 (sufficient charges) to the gray level voltage G32 (insufficient charges) according to the polarity signal POL of the liquid crystal panel 301. Thus, the selector 3046 can output the second overdrive voltage 18 to the pixel (P) according to the frame signal FS (that is, the second frame is updated to the third frame). In addition, subsequent operational principles of other intervals in FIG. 4A are the same, so further description thereof is omitted for simplicity. In Step 610, as shown in FIG. 4B, FIG. 4C, and FIG. 4D, at an interval T1 and an interval T2, because the polarity signal POL is not changed (+→+), the selector 3046 determines that the pixel voltage of the pixel (P) is changed from the gray level voltage G128 (insufficient charges) to the gray level voltage G32 (sufficient charges) according to the polarity signal POL of the liquid crystal panel 301. Thus, the selector 3046 can output the first overdrive voltage 22 to the pixel (P) according to the frame signal FS (that is, the first frame is updated to the second frame). At the interval T2 and an interval T3, because the polarity signal POL is changed (+→−), the selector 3046 determines that the pixel voltage of a pixel (P) is changed from the gray level voltage G32 (sufficient charge) to the gray level voltage G128 (insufficient charge) according to the polarity signal POL of the liquid crystal panel 301. Thus, the selector 3046 can output the second overdrive voltage 158 to the pixel (P) according to the frame signal FS (that is, the second frame is updated to the third frame). In addition, subsequent operational principles of other intervals in FIG. 4B are the same, so further description thereof is omitted for simplicity. In addition, when the first frame F1 and the second frame F2 are three-dimensional image frames, the frame signal FS can be a left/right eye signal or can be a vertical sync signal. But, in another embodiment of the present invention (as shown in FIG. 5), the frame signal FS is generated by the counter 30462 according to a period of time for the liquid crystal panel 301 displaying a frame. In addition, the present invention is not limited to the first frame F1 and the second frame F2 being the three-dimensional image frames. That is to say, the first frame F1 and the second frame F2 can be two-dimensional image frames. In addition, the polarity inversion type of the liquid crystal panel 301 which is the same as the polarity inversion type of the liquid crystal panel 100 in FIG. 1 is 2 frame inversion type.

To sum up, the circuit for outputting overdrive voltages of the liquid crystal panel and the method for outputting overdrive voltages of the liquid crystal panel utilize the overdrive unit to look up the first lookup table and the second lookup table to generate a first overdrive voltage and a second overdrive voltage according to each first pixel voltage of a plurality of first pixel voltages corresponding to a first frame displayed by the liquid crystal panel and a corresponding second pixel voltage of a plurality of second pixel voltages corresponding to a second frame displayed by the liquid crystal panel. Then, the selector outputs a first overdrive voltage or a second overdrive voltage to the liquid crystal panel according to a polarity signal and a frame signal of the liquid crystal panel. Thus, the present invention can utilize the overdrive unit to generate different overdrive voltages to solve crosstalk of the liquid crystal panel having the 2 frame inversion type.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A circuit for outputting overdrive voltages of a liquid crystal panel, the circuit comprising:
a memory unit for temporarily storing a plurality of second pixel voltages corresponding to a second frame displayed by the liquid crystal panel, and outputting a plurality of first pixel voltages corresponding to a first frame displayed by the liquid crystal panel stored in the memory unit; and
an overdrive unit for receiving the plurality of first pixel voltages and the plurality of second pixel voltages, the overdrive unit comprising:
a first lookup table comprising a plurality of first overdrive voltages;
a second lookup table comprising a plurality of second overdrive voltages, wherein the overdrive unit further looks up the first lookup table and the second lookup table to generate a first overdrive voltage and a second overdrive voltage according to each first pixel voltage of the plurality of first pixel voltages and a second pixel voltage of the plurality of second pixel voltages corresponding to the first pixel voltage; and
a selector for receiving the first overdrive voltage and the second overdrive voltage, and outputting the first overdrive voltage or the second overdrive voltage according to a polarity signal and a frame signal of the liquid crystal panel;
wherein the first frame is a previous frame before the second frame.

2. The circuit of claim 1, wherein the frame signal is a left/right eye signal when the first frame and the second frame are three-dimensional image frames.

3. The circuit of claim 1, wherein the frame signal is a vertical sync signal.

4. The circuit of claim 1, wherein the selector comprises:
a counter for generating the frame signal according to a period of time for the liquid crystal panel displaying a frame.

5. The circuit of claim 1, wherein the first frame and the second frame are two-dimensional image frames.

6. The circuit of claim 1, wherein a polarity inversion type of the liquid crystal panel is a 2 frame inversion type.

7. A method for outputting overdrive voltages of a liquid crystal panel, wherein a circuit for outputting the overdrive voltages of the liquid crystal panel comprises a memory unit and an overdrive unit, and the overdrive unit comprises a first lookup table, a second lookup table, and a selector, the method comprising:
the memory unit temporarily storing a plurality of second pixel voltages corresponding to a second frame displayed by the liquid crystal panel, and outputting a plurality of first pixel voltages corresponding to a first frame displayed by the liquid crystal panel stored in the memory unit;
the overdrive unit receiving the plurality of first pixel voltages and the plurality of second pixel voltages;
the overdrive unit looking up the first lookup table and the second lookup table to generate a first overdrive voltage and a second overdrive voltage according to each first pixel voltage of the plurality of first pixel voltages and a second pixel voltage of the plurality of second pixel voltages corresponding to the first pixel voltage;
the selector receiving the first overdrive voltage and the second overdrive voltage; and
the selector outputting the first overdrive voltage or the second overdrive voltage according to a polarity signal of the liquid crystal panel and a frame signal;
wherein the first frame is a previous frame before the second frame.

8. The method of claim 7, wherein the frame signal is a left/right eye signal when the first frame and the second frame are three-dimensional image frames.

9. The method of claim 7, wherein the frame signal is a vertical sync signal.

10. The method of claim 7, wherein the selector comprises:
a counter for generating the frame signal according to a period of time for the liquid crystal panel displaying a frame.

11. The method of claim 7, wherein the first frame and the second frame are two-dimensional image frames.

12. The method of claim 7, wherein a polarity inversion type of the liquid crystal panel is 2 frame inversion type.
